(19) United States
(12) Patent Application Publication
(10) Pub. No.: US 2023/0092683 A1
(43) Pub. Date: Mar. 23, 2023

(54) METHOD OF MAKING AN ELECTRODE

(71) Applicant: Utility Global, Inc., Houston, TX (US)

(72) Inventors: Nicholas Farandos, Bray (IE); Matthew Dawson, Katy, TX (US); Jin Dawson, Katy, TX (US); Hsuan-Yu Leu, Richmond, TX (US)

(73) Assignee: Utility Global, Inc., Houston, TX (US)

(21) Appl. No.: 17/941,306

(22) Filed: Sep. 9, 2022

Related U.S. Application Data
(60) Provisional application No. 63/242,669, filed on Sep. 10, 2021.

(51) Int. Cl. H01M 4/88; H01M 4/96; H01M 4/86

(52) U.S. Cl. CPC H01M 4/8846; H01M 4/96; H01M 4/8621; H01M 4/8626; H01M 4/8882

(57) ABSTRACT

Herein discussed is a method of making a copper-containing electrode comprising: (a) forming a copper solution; (b) forming a ceramic substrate; (c) infiltrating the ceramic substrate with the copper solution; and (d) calcining the infiltrated substrate using electromagnetic radiation, wherein the substrate is no thicker than 50 microns. In an embodiment, the method comprises repeating (c) and (d) until copper percolates the ceramic substrate.

### CROSS-REFERENCE TO RELATED APPLICATIONS

This application claims the benefit under 35 U.S.C. 119(e) of U.S. Provisional Pat. Application No. 63/242,669 filed Sep. 10, 2021, the entire disclosure of which is hereby incorporated herein by reference.

### TECHNICAL FIELD

This invention generally relates to electrochemical reactors. More specifically, this invention relates to electrodes in the electrochemical reactors and method of making.

### BACKGROUND

Hydrogen in large quantities is needed in the petroleum and chemical industries. For example, large amounts of hydrogen are used in upgrading fossil fuels and in the production of ammonia or methanol or hydrochloric acid. Petrochemical plants need hydrogen for hydrocracking, hydrodesulfurization, hydrodealkylation. Hydrogenation processes to increase the level of saturation of unsaturated fats and oils also need hydrogen. Hydrogen is also a reducing agent of metallic ores. Hydrogen may be produced from electrolysis of water, steam reforming, lab-scale metal-acid process, thermochemical methods, or anaerobic corrosion. Many countries are aiming at a hydrogen economy. Clearly there is increasing need and interest to develop new technological platforms to produce hydrogen. This disclosure discusses hydrogen production using efficient electrochemical pathways. The electrochemical reactor and the method to perform such reactions are discussed.

A fuel cell is also an electrochemical apparatus or reactor that converts the chemical energy from a fuel into electricity through an electrochemical reaction. There are many types of fuel cells. For example, solid oxide fuel cells (SOFCs) are a class of fuel cells that use a solid oxide material as the electrolyte. SOFCs use a solid oxide electrolyte to conduct negative oxygen ions from the cathode to the anode. The electrochemical oxidation of the oxygen ions with fuel (e.g., hydrogen, carbon monoxide) occurs on the anode side. Some SOFCs use proton-conducting electrolytes (PC-SOFCs) which transport protons instead of oxygen ions through the electrolyte. Typically, SOFCs using oxygen ion conducting electrolytes have higher operating temperatures than PC-SOFCs. In addition, SOFCs do not typically require expensive platinum catalyst materials which are typically necessary for lower temperature fuel cells (i.e., Proton Exchange Membrane Fuel Cells), and are not vulnerable to carbon monoxide catalyst poisoning. Solid oxide fuel cells have a wide variety of applications, such as auxiliary power units for homes and vehicles as well as stationary power generation units for data centers. SOFCs comprise interconnects, which are placed between each individual cell so that the cells are connected in series and that the electricity generated by each cell is combined. One category of SOFCs are segmented-in-series (SIS) type SOFCs. The electrical current flow in SIS type SOFCs is parallel to the electrolyte in the lateral direction. Contrary to the SIS type SOFC, a different category of SOFC has electrical current flow perpendicular to the electrolyte in the lateral direction. These two categories of SOFCs are connected differently and assembled differently.

As an example, copper-containing anodes in electrochemical reactors have excellent anti-coking properties, tolerance to sulfur, and enable the direct utilization of hydrocarbons. However, the making of such copper-containing anodes can be expensive, time consuming, and labor intensive. For at least these reasons, copper-containing anodes have not been generally adopted. As such, there is continuing need and interest to develop electrodes and methods of making that are commercially meaningful and industrially useful. The electrodes and methods of making as discussed herein are applicable not only for solid oxide fuel cells but also for other kinds of electrochemical reactors, such as electrochemical gas producers (hydrogen producers) and electrolysers.

### SUMMARY

Herein discussed is a method of making a copper-containing electrode comprising: (a) forming a copper solution; (b) forming a ceramic substrate; (c) infiltrating the ceramic substrate with the copper solution; and (d) calcining the infiltrated substrate using electromagnetic radiation, wherein the substrate is no thicker than 50 microns. In an embodiment, the method comprises repeating (c) and (d) until copper percolates the ceramic substrate.

In an embodiment, the ceramic substrate comprises CGO, CGO-YSZ, CGO-SSZ, SDC, SDC-YSZ, SDC-SSZ, undoped ceria, undoped ceria-YSZ, undoped ceria-SSZ, or combinations thereof. In an embodiment, the ceramic substrate is formed from ceramic particles. In an embodiment, the ceramic substrate is porous. In an embodiment, the ceramic substrate is furnace sintered. In an embodiment, the copper solution comprises copper, copper(I) nitrate, copper(II) nitrate, or combinations thereof. In an embodiment, the substrate is no thicker than 40 microns or 30 microns or 20 microns or 10 microns.

In an embodiment, the method comprises drying the substrate between (c) and (d) using a non-contact dryer. In an embodiment, the non-contact dryer comprises infrared heater, near infrared heater, hot air blower, ultraviolet light source, or combinations thereof.

In an embodiment, copper oxide particles remain after calcining and percolate the ceramic substrate. In an embodiment, calcining the infiltrated substrate using electromagnetic radiation causes temperature of a substrate surface to reach no less than 500° C., or no less than 600° C., or no less than 800° C. In an embodiment, infiltrating comprises depositing the solution on the substrate. In an embodiment, infiltrating comprises incorporation of the solution into the ceramic substrate. In an embodiment, incorporation comprises capillary forces or vacuum or both. In an embodiment, depositing comprises inkjet printing, ultrasonic inkjet printing, material jetting, binder jetting, aerosol jetting, aerosol jet printing, dip coating, spraying, spin coating, brush coating, pasting, or combinations thereof.

In an embodiment, the substrate is planar or tubular. In an embodiment, the substrate comprises cobalt. In an embodiment, the electromagnetic radiation is provided by a xenon lamp. In an embodiment, the electromagnetic radiation comprises UV light, near ultraviolet light, near infrared light, infrared light, visible light, laser, electron beam, microwave, or combinations thereof. In an embodiment, the electromagnetic radiation comprises a single exposure. In an embodiment, the single exposure duration is no greater than 10 ms or no greater than 5 ms or no greater than 2 ms or no greater than 1 ms or in the range of 0.1-1 ms. In an embodiment, the electromagnetic radiation comprises multiple exposures with a total exposure duration and an exposure frequency. In an embodiment, the total exposure duration is no greater than 10 s or no greater than 5 s or no greater than 1 s.

Also discussed herein is a method of making an electrode comprising: (a) forming a ceria solution; (b) forming a ceramic substrate; (c) infiltrating the ceramic substrate with the ceria solution; and (d) calcining the infiltrated substrate using electromagnetic radiation, wherein the substrate is no thicker than 50 microns. In an embodiment, the ceria solution comprises ceria nitrate. In an embodiment, the ceria is undoped. In an embodiment, the ceramic substrate comprises CGO, CGO-YSZ, CGO-SSZ, SDC, SDC-YSZ, SDC-SSZ, undoped ceria, undoped ceria-YSZ, undoped ceria-SSZ, or combinations thereof. In an embodiment, the method comprises repeating (c) and (d) until ceria percolates the ceramic substrate.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates an electrochemical (EC) reactor or an electrochemical gas producer, according to an embodiment of this disclosure.

FIG. 2A illustrates a tubular electrochemical reactor, according to an embodiment of this disclosure.

FIG. 2B illustrates a cross section of a tubular electrochemical reactor, according to an embodiment of this disclosure.

FIG. 3 illustrates a process of making a copper electrode, according to an embodiment of this disclosure.

FIG. 4A illustrates a portion of a method of manufacturing an electrochemical reactor using a single point EMR source, according to an embodiment of the disclosure.

FIG. 4B illustrates a portion of a method of manufacturing an electrochemical reactor using a ring-lamp EMR source, according to an embodiment of the disclosure.

FIG. 4C illustrates a portion of a method of manufacturing an electrochemical reactor using a single point EMR source, according to an embodiment of the disclosure.

FIG. 4D illustrates a portion of a method of manufacturing an electrochemical reactor using a tubular EMR source, according to an embodiment of the disclosure.

### DETAILED DESCRIPTION

Embodiments of methods, materials and processes described herein are directed towards copper-containing electrodes for electrochemical reactors. Electrochemical reactors include solid oxide fuel cells, solid oxide fuel cell stacks, electrochemical gas producers (or alternatively termed electrochemical reactors in this disclosure), electrochemical compressors, solid state batteries, electrolysers, or solid oxide flow batteries.

### Overview

Embodiments of the invention are directed towards copper-containing electrodes for electrochemical reactors. These electrochemical reactors can include solid oxide fuel cells (SOFC’s), solid oxide fuel cell stacks, electrochemical gas producers, electrochemical compressors, solid state batteries, electrolysers, or solid oxide flow batteries. The electrodes can be described as having both a copper or copper oxide phase and a ceramic phase. These two phases are sintered and are inter-dispersed with one another. By being inter-dispersed, fluids entering the electrode can contact both phases, thus facilitating the function of the ceramic phase of the electrode in the electrochemical cell. In other words, if the copper or copper oxide phase completely coated the ceramic phase, the ceramic phase could not perform its function in the electrochemical cell.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the phrase A and B are inter-dispersed with one another means that phase A and phase B coexist and intertwine with one another and excludes the case wherein one phase largely coats the other phase. In other words, when phases A and B are inter-dispersed with one another, the two phases are identifiable and neither phase completely nor substantially coats the other phase. In this way, fluids passing into the inter-dispersed phases make contact with both phases.

As used herein, to say that A percolates B means that particles of A, sometimes in clusters, are connected to form a larger network of A that connects one side of the electrode to the other, resulting in connectivity of A throughout B. For example, if a copper phase (A) percolates an electrode (B), then the electrode is able to conduct electrons through the copper phase. This does not necessarily mean that every particle of A is connected to the network but does mean that there are enough particles connected to form a continuous phase from one side to the other.

Preferably, the copper or copper oxide phase percolates the ceramic phase. In this way, a conductive pathway is formed from one side of the electrode to the other side. For example, an electrochemical cell is assembled with an electrode having a copper oxide phase. At the initiation of operation, a reducing gas, such as H₂ is run through electrode to create copper phase to conduct electrons. In this disclosure, copper electrode refers to an electrode that contains copper either as an element or as a compound. As used herein, copper oxide includes both CuO and Cu₂O.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

As used herein, YSZ refers to yttria-stabilized zirconia; SDC refers to samaria-doped ceria; SSZ refers to scandia-stabilized zirconia; LSGM refers to lanthanum strontium gallate magnesite.

In this disclosure, no substantial amount of H₂ means that the volume content of the hydrogen is no greater than 5%, or no greater than 3%, or no greater than 2%, or no greater than 1%, or no greater than 0.5%, or no greater than 0.1%, or no greater than 0.05%.

As used herein, CGO refers to Gadolinium-Doped Ceria, also known alternatively as gadolinia-doped ceria, gadolinium-doped cerium oxide, cerium(IV) oxide, gadolinium-doped, GDC, or GCO, (formula Gd:CeO₂). CGO and GDC are used interchangeably unless otherwise specified. Syngas (i.e., synthesis gas) in this disclosure refers to a mixture consisting primarily of hydrogen, carbon monoxide and carbon dioxide.

A mixed conducting membrane is able to transport both electrons and ions. Ionic conductivity includes ionic species such as oxygen ions (or oxide ions), protons, halogenide anions, chalcogenide anions. In various embodiment, the mixed conducting membrane of this disclosure comprises an electronically conducting phase and an ionically conducting phase.

In this disclosure, the axial cross section of the tubulars is shown to be circular, which is illustrative only and not limiting. The axial cross section of the tubulars is any suitable shape as known to one skilled in the art, such as square, square with rounded corners, rectangle, rectangle with rounded corners, triangle, hexagon, pentagon, oval, irregular shape, etc.

As used herein, ceria refers to cerium oxide, also known as ceric oxide, ceric dioxide, or cerium dioxide, is an oxide of the rare-earth metal cerium. Doped ceria refers to ceria doped with other elements, such as samaria-doped ceria (SDC), or gadolinium-doped ceria (GDC or CGO). As used herein, chromite refers to chromium oxides, which includes all the oxidation states of chromium oxides.

A layer or substance being impermeable as used herein refers to it being impermeable to fluid flow. For example, an impermeable layer or substance has a permeability of less than 1 micro darcy, or less than 1 nano darcy.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece.

Electrochemistry is the branch of physical chemistry concerned with the relationship between electrical potential, as a measurable and quantitative phenomenon, and identifiable chemical change, with either electrical potential as an outcome of a particular chemical change, or vice versa. These reactions involve electrons moving between electrodes via an electronically-conducting phase (typically, but not necessarily, an external electrical circuit), separated by an ionically-conducting and electronically insulating membrane (or ionic species in a solution). When a chemical reaction is effected by a potential difference, as in electrolysis, or if electrical potential results from a chemical reaction as in a battery or fuel cell, it is called an electrochemical reaction. Unlike chemical reactions, in electrochemical reactions electrons (and necessarily resulting ions), are not transferred directly between molecules, but via the aforementioned electronically conducting and ionically conducting circuits, respectively. This phenomenon is what distinguishes an electrochemical reaction from a chemical reaction.

Related to the electrochemical reactor and methods of use, various components of the reactor are described such as electrodes and membranes along with materials of construction of the components. The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

The term “in situ” in this disclosure refers to the treatment (e.g., heating) process being performed either at the same location or in the same device of the forming process of the compositions or materials. For example, the deposition process and the heating process are performed in the same device and at the same location, in other words, without changing the device and without changing the location within the device. For example, the deposition process and the heating process are performed in the same device at different locations, which is also considered in situ.

As used herein, lateral refers to the direction that is perpendicular to the stacking direction of the layers in a non-SIS type fuel cell. Thus, lateral direction refers to the direction that is perpendicular to the stacking direction of the layers in a fuel cell or the stacking direction of the slices to form an object during deposition. Lateral also refers to the direction that is the spread of deposition process.

In this disclosure, absorbance is a measure of the capacity of a substance to absorb electromagnetic radiation (EMR) of a wavelength. Absorption of radiation refers to the energy absorbed by a substance when exposed to the radiation.

An interconnect in an electrochemical device (e.g., a fuel cell) is often either metallic or ceramic that is placed between the individual cells or repeat units. Its purpose is to connect each cell or repeat unit so that electricity can be distributed or combined. An interconnect is also referred to as a bipolar plate in an electrochemical device. An interconnect being an impermeable layer as used herein refers to it being a layer that is impermeable to fluid flow. Electrochemical Reactor

Contrary to conventional practice, an electrochemical reactor has been discovered, which comprises an ionically conducting membrane, wherein the reactor is capable of reforming a hydrocarbon electrochemically or of performing water gas shift reactions electrochemically. The electrochemical reforming reactions involve the exchange of an ion through the membrane to oxidize the hydrocarbon. The electrochemical water gas shift reactions involve the exchange of an ion through the membrane and include forward water gas shift reactions, or reverse water gas shift reactions, or both. These are different from traditional reforming reactions and water gas shift reactions via chemical pathways because they involve direct combination of reactants.

In an embodiment, the reactor comprises porous electrodes that comprise metallic phase and ceramic phase, wherein the metallic phase is electronically conductive and wherein the ceramic phase is ionically conductive. In various embodiments, the electrodes have no current collector attached to them. In various embodiments, the reactor does not contain any current collector. Clearly, such a reactor is fundamentally different from any electrolysis device or fuel cell.

In an embodiment, one of the electrodes in the reactor is an anode that is configured to be exposed to a reducing environment while performing oxidation reactions electrochemically. In various embodiments, the electrodes comprise Ni or NiO and a material selected from the group consisting of YSZ, CGO, SDC, SSZ, LSGM, and combinations thereof.

The electrochemical water gas shift reactions taking place in the reactor comprise electrochemical half-cell reactions, wherein the half-cell reactions are:

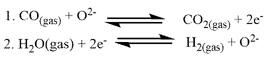

In various embodiments, the half-cell reactions take place at triple phase boundaries, wherein the triple phase boundaries are the intersections of pores with the electronically conducting phase and the ionically conducting phase. Furthermore, the reactor is also capable of performing chemical water gas shift reactions.

In various embodiments, the ionically conducting membrane conducts protons or oxide ions. In various embodiments, the ionically conducting membrane comprises solid oxide. In various embodiments, the ionically conducting membrane is impermeable to fluid flow. In various embodiments, the ionically conducting membrane also conducts electrons and wherein the reactor comprises no interconnect.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, or combinations thereof.

Also discussed herein is a reactor comprising a bi-functional layer and a mixed conducting membrane; wherein the bi-functional layer and the mixed conducting membrane are in contact with each other, and wherein the bi-functional layer catalyzes reverse-water-gas-shift (RWGS) reaction and functions as an anode in an electrochemical reaction. In an embodiment, the bi-functional layer as the anode is exposed to a reducing environment and the electrochemical reaction taking place in the bi-functional layer is oxidation. In an embodiment, no current collector is attached to the bi-functional layer. In an embodiment, the bi-functional layer comprises Ni or NiO and a material selected from the group consisting of YSZ, CGO, SDC, SSZ, LSGM, and combinations thereof.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, or combinations thereof.

Such a reactor has various applications. In an embodiment, the reactor is utilized to produce carbon monoxide via hydrogenation of carbon dioxide. In another embodiment, the reactor is used to adjust syngas composition (i.e., H₂/CO ratio) by converting H₂ to CO or converting CO to H₂. The following discussion takes hydrogen production as an example, but the application of the reactor is not limited to only hydrogen production.

Herein discussed is an electrochemical reactor comprising an ionically conducting membrane, wherein the reactor is capable of reforming a hydrocarbon electrochemically, wherein the electrochemical reforming reactions involve the exchange of an ion through the membrane to oxidize the hydrocarbon. In an embodiment, the reactor comprises porous electrodes that comprise metallic phase and ceramic phase, wherein the metallic phase is electronically conductive, and wherein the ceramic phase is ionically conductive. In an embodiment, the electrodes have no current collector attached. In an embodiment, the electrodes are separated by the membrane and are both exposed to a reducing environment.

In an embodiment, one of the electrodes comprises Ni or NiO and a material selected from the group consisting of YSZ, CGO, SDC, SSZ, LSGM, and combinations thereof, and wherein the other of the electrodes comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof. In an embodiment, the other of the electrodes comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the lanthanum chromite comprises undoped lanthanum chromite, strontium doped lanthanum chromite, iron doped lanthanum chromite, strontium and iron doped lanthanum chromite, lanthanum calcium chromite, or combinations thereof.

In an embodiment, the electrochemical reforming reactions comprise electrochemical half-cell reactions, wherein the half-cell reactions are (e.g., when the hydrocarbon is methane):
1. CH₄ + O₂ ⇌ CO + 2H₂ + 2e⁻
2. H₂O + 2e⁻ ⇌ H₂ + O²⁻

In an embodiment, the half-cell reactions take place at triple phase boundaries, wherein the triple phase boundaries are the intersections of pores with the electronically conducting phase and the ionically conducting phase. In an embodiment, the ionically conducting membrane conducts protons or oxide ions. In an embodiment, the ionically conducting membrane is impermeable to fluid flow. In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, or combinations thereof.

In an embodiment, the membrane comprises gadolinium doped ceria (CGO) or samarium doped ceria (SDC) or both. In an embodiment, the membrane consists of gadolinium doped ceria (CGO) or samarium doped ceria (SDC) or both. In an embodiment, the ionically conducting membrane also conducts electrons and wherein the reactor comprises no interconnect.

Further discussed herein is a reactor comprising: an anode and a mixed conducting membrane; wherein the anode and the mixed conducting membrane are in contact with each other, and wherein the anode promotes electrochemical hydrocarbon reforming reactions. In an embodiment, the anode is exposed to a reducing environment and the electrochemical reaction taking place in anode is oxidation. In an embodiment, no current collector is attached to the anode. In an embodiment, the reactor has no interconnect.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, or combinations thereof. In an embodiment, the membrane comprises gadolinium doped ceria (CGO) or samarium doped ceria (SDC) or both. In an embodiment, the membrane consists of gadolinium doped ceria (CGO) or samarium doped ceria (SDC) or both.

In an embodiment, the anode comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof. In an embodiment, the anode comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the lanthanum chromite comprises undoped lanthanum chromite, strontium doped lanthanum chromite, iron doped lanthanum chromite, strontium and iron doped lanthanum chromite, lanthanum calcium chromite, or combinations thereof.

Also discussed herein is a method of producing hydrogen comprising providing an electrochemical (EC) reactor having a mixed-conducting membrane, introducing a first stream comprising a hydrocarbon to the reactor, introducing a second stream comprising water to the reactor, and reducing the water in the second stream to produce hydrogen, wherein the first stream and the second stream do not come in contact with each other in the reactor, and wherein the hydrocarbon is reformed electrochemically in the EC reactor. In an embodiment, the method comprises recycling at least portion of the produced hydrogen to the first stream or the second stream or both.

In an embodiment, the reduction from water to hydrogen takes place electrochemically. In an embodiment, water in the second stream is steam. In an embodiment, the first stream and the second stream are separated by the membrane. In an embodiment, the second stream comprises hydrogen. In an embodiment, the first stream consists essentially of a hydrocarbon and hydrogen.

In an embodiment, the EC reactor comprises an anode on the first stream side and a cathode on the second stream side, wherein the anode and the cathode are separated by the membrane and are in contact with the membrane respectively. In an embodiment, the anode and the cathode are separated by the membrane and are both exposed to a reducing environment.

In an embodiment, the anode comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof; and wherein the cathode comprises Ni or NiO and a material selected from the group consisting of YSZ, CGO, SDC, SSZ, LSGM, and combinations thereof. In an embodiment, the anode comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof; wherein the cathode comprises Ni or NiO and a material selected from the group consisting of YSZ, CGO, SDC, SSZ, LSGM, and combinations thereof. In an embodiment, the lanthanum chromite comprises undoped lanthanum chromite, strontium doped lanthanum chromite, iron doped lanthanum chromite, strontium and iron doped lanthanum chromite, lanthanum calcium chromite, or combinations thereof.

In an embodiment, the reactor comprises no interconnect. In an embodiment, the reactor does not generate electricity and does not need electricity to operate. In an embodiment, the first stream has a temperature of no less than 700° C. or no less than 800° C. or no less than 900° C.

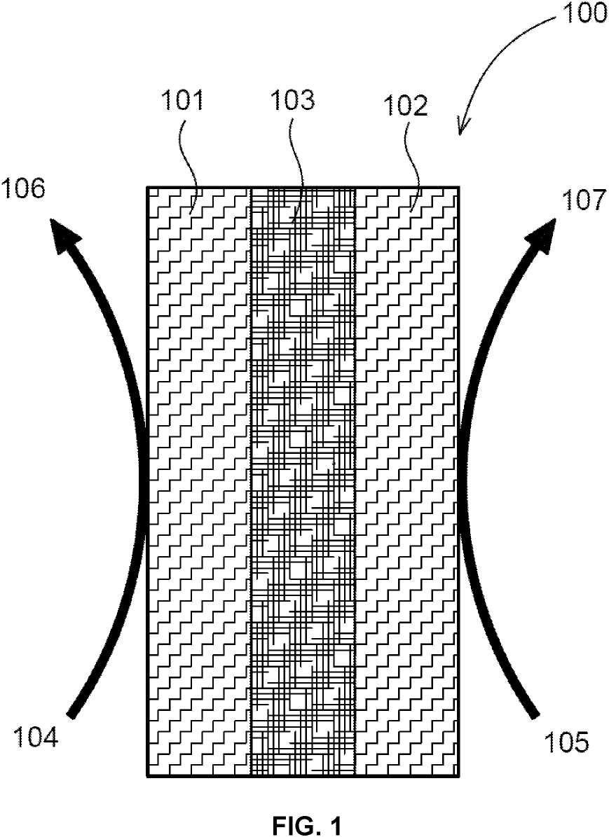

FIG. 1 illustrates an electrochemical reactor or an electrochemical (EC) gas producer 100, according to an embodiment of this disclosure electrochemical reactor (or EC gas producer) device 100 comprises first electrode 101, membrane 103 a second electrode 102. First electrode 101 (also referred to as anode or bi-functional layer) is configured to receive a fuel 104. Stream 104 contains no oxygen. Second electrode 102 is configured to receive water (e.g., steam) as denoted by 105.

In an embodiment, device 100 is configured to receive CO, i.e., carbon monoxide (104) and to generate CO/CO₂ (106) at the first electrode (101); device 100 is also configured to receive water or steam (105) and to generate hydrogen (107) at the second electrode (102). In some cases, the second electrode receives a mixture of steam and hydrogen. Since water provides the oxide ion (which is transported through the membrane) needed to oxidize the CO at the opposite electrode, water is considered the oxidant in this scenario. As such, the first electrode 101 is performing oxidation reactions in a reducing environment. In various embodiments, 103 represents an oxide ion conducting membrane. In an embodiment, the first electrode 101 and the second electrode 102 comprise Ni-YSZ or NiO-YSZ. In an embodiment, the oxide ion conducting membrane 103 also conducts electrons. In these cases, gases containing H₂, CO, syngas, or combinations thereof are suitable as feed stream 104. In various embodiments, electrodes 101 and 102 comprise Ni or NiO and a material selected from the group consisting of YSZ, CGO, SDC, SSZ, LSGM, and combinations thereof. Alternatively, gases containing a hydrocarbon are reformed before coming into contact with the membrane 103/electrode 101. The reformer is configured to perform steam reforming, dry reforming, or combination thereof. The reformed gases are suitable as feed stream 104.

In an embodiment, device 100 is configured to simultaneously produce hydrogen 107 from the second electrode 102 and syngas 106 from the first electrode 101. In an embodiment, 104 represents methane and water or methane and carbon dioxide entering device 100. In another embodiment, 104 represents methane. In other embodiments, 103 represents an oxide ion conducting membrane. Arrow 104 represents an influx of hydrocarbon and water or hydrocarbon and carbon dioxide. Arrow 105 represents an influx of water or water and hydrogen. In some embodiments, electrode 101 comprises Cu-CGO, or further optionally comprises CuO or Cu₂O or combination thereof; electrode 102 comprises Ni-YSZ or NiO-YSZ. In some cases, electrode 101 comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof; and electrode 102 comprises Ni or NiO and a material selected from the group consisting of YSZ, CGO, SDC, SSZ, LSGM, and combinations thereof. In some cases, electrode 101 comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof; electrode 102 comprises Ni or NiO and a material selected from the group consisting of YSZ, CGO, SDC, SSZ, LSGM, and combinations thereof. In various embodiments, the lanthanum chromite comprises undoped lanthanum chromite, strontium doped lanthanum chromite, iron doped lanthanum chromite, strontium and iron doped lanthanum chromite, lanthanum calcium chromite, or combinations thereof.

Arrow 104 represents an influx of hydrocarbon with little to no water, with no carbon dioxide, and with no oxygen, and 105 represents an influx of water or water and hydrogen. Since water provides the oxide ion (which is transported through the membrane) needed to oxidize the hydrocarbon/fuel at the opposite electrode, water is considered the oxidant in this scenario. In these cases, gases containing a hydrocarbon are suitable as feed stream 104 and reforming of the gases is not necessary. In these cases, electrochemical reforming is enabled by the reactor, where the oxygen needed to reform the methane derives from the reduction of water, and it is supplied across the membrane. The half-cell reactions are electrochemical and are as follows:

$$\begin{matrix}C {H}_{4} + {O}_{2} ⇌ C O + 2 {H}_{2} + 2 {e}^{-} ( a t t h e a n o d e ) \\ {H}_{2} O + 2 {e}^{-} ⇌ {H}_{2} + {O}^{2 -} ( a t t h e c a t h o d e )\end{matrix}$$

In this disclosure, no oxygen means there is no oxygen present at first electrode 101 or at least not enough oxygen that would interfere with the reaction. Also, in this disclosure, water only means that the intended feedstock is water and does not exclude trace elements or inherent components in water. For example, water containing salts or ions is considered to be within the scope of water only. Water only also does not require 100% pure water but includes this embodiment. In embodiments, the hydrogen produced from second electrode 102 is pure hydrogen, which means that in the produced gas phase from the second electrode, hydrogen is the main component. In some cases, the hydrogen content is no less than 99.5%. In some cases, the hydrogen content is no less than 99.9%. In some cases, the hydrogen produced from the second electrode is the same purity as that produced from electrolysis of water.

In an embodiment, first electrode 101 is configured to receive methane or methane and water or methane and carbon dioxide. In an embodiment, the fuel comprises a hydrocarbon having a carbon number in the range of 1-12, 1-10 or 1-8. Most preferably, the fuel is methane or natural gas, which is predominantly methane. In an embodiment, the device does not generate electricity and is not a fuel cell.

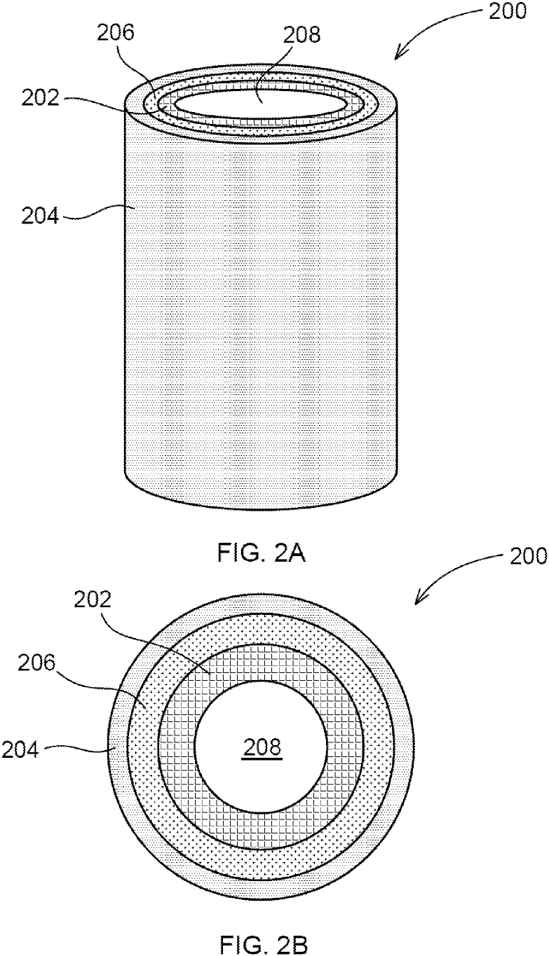

In various embodiments, the device does not contain a current collector. In an embodiment, the device comprises no interconnect. There is no need for electricity and such a device is not an electrolyzer. This is a major advantage of the EC reactor of this disclosure. The membrane 103 is configured to conduct electrons and as such is mixed conducting, i.e., both electronically conductive and ionically conductive. In an embodiment, the membrane 103 conducts oxide ions and electrons. In an embodiment, the electrodes 101, 102 and the membrane 103 are tubular (see, e.g., FIGS. 2A and 2B). In an embodiment, the electrodes 101, 102 and the membrane 103 are planar. In these embodiments, the electrochemical reactions at the anode and the cathode are spontaneous without the need to apply potential/electricity to the reactor.

In an embodiment, the electrochemical reactor (or EC gas producer) is a device comprising a first electrode, a second electrode, and a membrane between the electrodes, wherein the first electrode and the second electrode comprise a metallic phase that does not contain a platinum group metal when the device is in use, and wherein the membrane is oxide ion conducting. In an embodiment, the first electrode is configured to receive a fuel. In an embodiment, said fuel comprises a hydrocarbon or hydrogen or carbon monoxide or combinations thereof. In an embodiment, the second electrode is configured to receive water and hydrogen and configured to reduce the water to hydrogen. In various embodiments, such reduction takes place electrochemically.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, or combinations thereof.

FIG. 2A illustrates (not to scale) a tubular electrochemical (EC) reactor or an EC gas producer 200, according to an embodiment of this disclosure. Tubular producer 200 includes an inner tubular structure 202, an outer tubular structure 204, and a membrane 206 disposed between the inner and outer tubular structures 202, 204, respectively. Tubular producer 200 further includes a void space 208 for fluid passage. FIG. 2B illustrates (not to scale) a cross section of a tubular producer 200, according to an embodiment of this disclosure. Tubular producer 200 includes a first inner tubular structure 202, a second outer tubular structure 204, and a membrane 206 between the inner and outer tubular structures 202, 204. Tubular producer 200 further includes a void space 208 for fluid passage.

In an embodiment, the electrodes and the membrane are tubular with the first electrode being outermost and the second electrode being innermost, wherein the second electrode is configured to receive water and hydrogen. In an embodiment, the electrodes and the membrane are tubular with the first electrode being innermost and the second electrode being outermost, wherein the second electrode is configured to receive water and hydrogen. In an embodiment, the electrodes and the membrane are tubular.

In an embodiment, the reactor comprises a catalyst that promotes chemical reverse water gas shift (RWGS) reactions. In an embodiment, the catalyst is a high temperature RWGS catalyst. In an embodiment, the catalyst is part of an anode in the reactor. In an embodiment, the catalyst is configured to be outside of the anode. For example, Ni—Al₂O₃ pellets as such a catalyst are placed in the reactor surrounding the tubes as shown in FIG. 2A and FIG. 2B. In an embodiment, the catalyst comprises Ni, Cu, Fe, Pt-group metals, or combinations thereof. In an embodiment, the catalyst comprises Pt, Cu, Rh, Ru, Fe, Ni, or combinations thereof.

Herein discussed is a method of producing hydrogen comprising providing an electrochemical (EC) reactor having a mixed-conducting membrane, introducing a first stream comprising a fuel to the reactor, introducing a second stream comprising water to the reactor, reducing the water in the second stream to produce hydrogen, and recycling at least portion of the produced hydrogen to the first stream, wherein the first stream and the second stream do not come in contact with each other in the reactor.

In an embodiment, the reduction from water to hydrogen takes place electrochemically. In an embodiment, water in the second stream is steam. In an embodiment, the first stream and the second stream are separated by the membrane. In an embodiment, the second stream comprises hydrogen and wherein optionally the first stream comprises water, carbon dioxide, an inert gas, or combinations thereof. In an embodiment, the fuel comprises a hydrocarbon, carbon monoxide, hydrogen, or combinations thereof. In an embodiment, the first stream consists essentially of a hydrocarbon and recycled hydrogen.

In an embodiment, the EC reactor comprises an anode on the first stream side and a cathode on the second stream side, wherein the anode and the cathode are separated by the membrane and are in contact with the membrane respectively. In an embodiment, the anode and the cathode are separated by the membrane and are both exposed to a reducing environment. In an embodiment, the anode and the cathode comprise Ni or NiO and a material selected from the group consisting of YSZ, CGO, SDC, SSZ, LSGM, and combinations thereof. In an embodiment, the anode comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof; and wherein the cathode comprises Ni or NiO and a material selected from the group consisting of YSZ, CGO, SDC, SSZ, LSGM, and combinations thereof.

In an embodiment, the anode comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof; wherein the cathode comprises Ni or NiO and a material selected from the group consisting of YSZ, CGO, SDC, SSZ, LSGM, and combinations thereof; and wherein optionally the lanthanum chromite comprises undoped lanthanum chromite, strontium doped lanthanum chromite, iron doped lanthanum chromite, strontium and iron doped lanthanum chromite, lanthanum calcium chromite, or combinations thereof.

In an embodiment, at least a portion of the anode exhaust gas is used to produce steam from water. In an embodiment, at least a portion of the anode exhaust gas is sent to a carbon capture unit. In an embodiment, the method comprises recycling at least portion of the produced hydrogen to the second stream.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, or combinations thereof. In an embodiment, the membrane comprises gadolinium doped ceria (CGO), samarium doped ceria (SDC). In an embodiment, the membrane consists of gadolinium doped ceria (CGO), samarium doped ceria (SDC).

In an embodiment, the membrane is impermeable to fluid flow. In an embodiment, the membrane conducts protons or oxide ions. In an embodiment, the membrane also conducts electrons and wherein the reactor comprises no interconnect. In an embodiment, the reactor does not generate electricity and does not need electricity to operate. In an embodiment, the first stream has a temperature of no less than 700° C. or no less than 800° C. or no less than 900° C.

### Electrodes

An electrode of this disclosure comprises a copper or copper oxide phase and a ceramic phase, wherein the copper or copper oxide phase and the ceramic phase are sintered and are inter-dispersed with one another. In an embodiment, the copper phase is formed by infiltration (e.g., as a copper salt solution) through the ceramic phase.

In various embodiments, the copper or copper oxide phase percolates the electrode, meaning that enough of the copper or copper oxide particles are connected to form a network from one side of the electrode to the other. In this way, the copper particles or the copper oxide particles when reduced to form copper form a path to conduct electrons from one side of the electrode to the other.

In an embodiment, the ceramic phase comprises CGO, CGO-YSZ, CGO-SSZ, SDC, SDC-YSZ, SDC-SSZ, undoped ceria, undoped ceria-YSZ, undoped ceria-SSZ, or combinations thereof. In an embodiment, CGO is preferred. In an embodiment, the ceramic phase/substrate comprises cobalt. In an embodiment, forming the ceramic substrate comprises oven sintering or furnace sintering. In an embodiment, the ceramic substrate comprises sintered ceramic particles.

In an embodiment, a method of making a copper-containing electrode comprises: (a) forming a copper solution; (b) forming a ceramic substrate; (c) infiltrating the ceramic substrate with the copper solution; and (d) calcining the infiltrated substrate using electromagnetic radiation, wherein the substrate is no thicker than 50 microns.

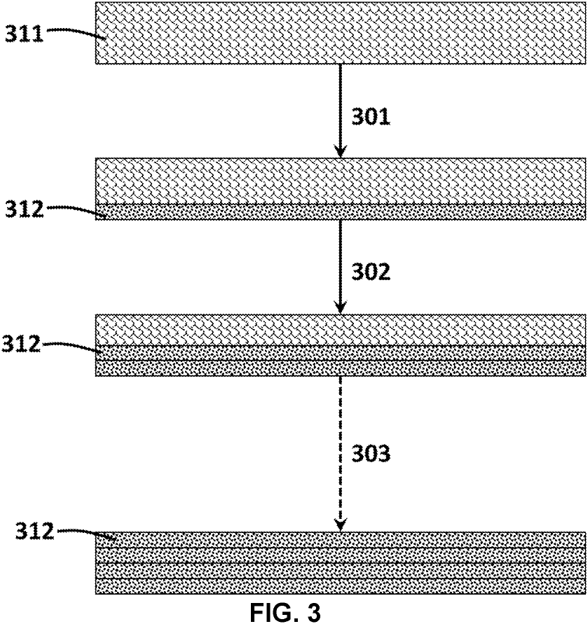

In an embodiment, the method comprises repeating (c) and (d) until copper percolates the ceramic substrate. As illustrated in FIG. 3, 311 represents a ceramic substrate, which is infiltrated with a copper solution and calcined using EMR. 301 represents a first infiltration and calcination step. A ceramic substrate slice percolated with copper (or copper oxide) is thus formed, as represented by 312. A second infiltration and EMR calcination step (302) is performed and another slice 312 is formed. 303 represents one or more infiltration and EMR calcination steps until copper percolates the ceramic substrate. In an embodiment, the slice has a thickness in the range of 200 nm - 20 microns. In an embodiment, the slice has a thickness in the range of 200 nm - 10 microns. In an embodiment, the slice has a thickness in the range of 200 nm - 5 microns. In an embodiment, the slice has a thickness in the range of 200 nm - 2 microns.

In an embodiment, the ceramic substrate comprises CGO, CGO-YSZ, CGO-SSZ, SDC, SDC-YSZ, SDC-SSZ, undoped ceria, undoped ceria-YSZ, undoped ceria-SSZ, or combinations thereof. In an embodiment, the ceramic substrate is formed from ceramic particles. In an embodiment, the ceramic substrate is porous. In an embodiment, the ceramic substrate is furnace sintered. In an embodiment, the copper solution comprises copper, copper(I) nitrate, copper(II) nitrate, or combinations thereof. In an embodiment, the substrate is no thicker than 40 microns or 30 microns or 20 microns or 10 microns.

In an embodiment, the method comprises drying the substrate between (c) and (d) using a non-contact dryer. In an embodiment, the non-contact dryer comprises infrared heater, near infrared heater, hot air blower, ultraviolet light source, or combinations thereof.

In an embodiment, copper oxide particles remain after calcining and percolate the ceramic substrate. In an embodiment, calcining the infiltrated substrate using electromagnetic radiation causes temperature of a substrate surface to reach no less than 500° C., or no less than 600° C., or no less than 800° C. In an embodiment, infiltrating comprises depositing the solution on the substrate. In an embodiment, infiltrating comprises incorporation of the solution into the ceramic substrate. In an embodiment, incorporation comprises capillary forces or vacuum or both. In an embodiment, depositing comprises inkjet printing, ultrasonic inkjet printing, material jetting, binder jetting, aerosol jetting, aerosol jet printing, dip coating, spraying, spin coating, brush coating, pasting, or combinations thereof.

In an embodiment, the substrate is planar or tubular. In an embodiment, the substrate comprises cobalt. In an embodiment, the electromagnetic radiation is provided by a xenon lamp. In an embodiment, the electromagnetic radiation comprises UV light, near ultraviolet light, near infrared light, infrared light, visible light, laser, electron beam, microwave, or combinations thereof. In an embodiment, the electromagnetic radiation comprises a single exposure. In an embodiment, the single exposure duration is no greater than 10 ms or no greater than 5 ms or no greater than 2 ms or no greater than 1 ms or in the range of 0.1-1 ms. In an embodiment, the electromagnetic radiation comprises multiple exposures with a total exposure duration and an exposure frequency. In an embodiment, the total exposure duration is no greater than 10 s or no greater than 5 s or no greater than 1 s.

In an embodiment, the copper or copper oxide phase constitutes 10-90 wt% of the electrode on the basis of total solids. In an embodiment, the copper or copper oxide phase constitutes 20-80 wt% of the electrode on the basis of total solids. In an embodiment, the copper or copper oxide phase constitutes 30-70 wt% of the electrode on the basis of total solids.

In an embodiment, at least a population of the ceramic particles are smaller than the copper or copper oxide particles on average. In an embodiment, at least another population of the ceramic particles are larger than the copper or copper oxide particles on average. For example, a population of the ceramic particles have an average diameter of 10-30 nm, another population of the ceramic particles have an average diameter of 160-300 nm, and the copper or copper oxide particles have an average diameter of 40-120 nm. In an embodiment, the ceramic particles have an average diameter of 10-1000 nm, and the copper or copper oxide particles have an average diameter of 10-1000 nm.

In an embodiment, the electrode further comprises cobalt, cobalt oxide, gold, gold oxide, lanthanum chromite, stainless steel, or combinations thereof. In an embodiment, the electrode further comprises nickel, nickel oxide, or combinations thereof. In an embodiment, the electrode further comprises ruthenium, rhodium, palladium, osmium, iridium, platinum, or combinations thereof. In an embodiment, copper in the electrode may be replaced by gold, ruthenium, rhodium, palladium, osmium, iridium, platinum, or combinations thereof. The method of this disclosure is applicable for making electrodes using these alternative metals as the conductive phase of the electrode.

The porosity of the electrode provides access for fluids to pass into the electrode to facilitate operation of the electrochemical cell. In an embodiment, the electrode has a porosity of 20% or higher without accounting for fluid channels or fluid dispersing components. In an embodiment, the electrode has a porosity of 30% or higher without accounting for fluid channels or fluid dispersing components. In an embodiment, the electrode has a porosity of 40% or higher without accounting for fluid channels or fluid dispersing components.

In an embodiment, the ceramic particles comprise CGO, CGO-YSZ, CGO-SSZ, SDC, SDC-YSZ, SDC-SSZ, undoped ceria, undoped ceria-YSZ, undoped ceria-SSZ, or combinations thereof. In an embodiment, depositing comprises inkjet printing, ultrasonic inkjet printing, material jetting, binder jetting, aerosol jetting, aerosol jet printing, dip coating, spraying, spin coating, brush coating, pasting, or combinations thereof. In an embodiment, the substrate is planar or tubular. In an embodiment, the electromagnetic radiation is provided by a xenon lamp.

When the electrode is initiated into operation, a reducing gas (such as CO or H₂) is passed through the electrode to reduce at least a portion of copper oxide to copper so that the electrode is able to conduct electrons. The reduction process takes place at a temperature no greater than 1000° C. or no greater than 900° C. In some cases, the reduction process takes place at a temperature in the range of from 100° C. to 350° C. The duration of reduction depends on various factors, such as the size and number of the electrodes, reducing gas composition, reducing gas temperature, reducing gas pressure, and reducing gas flow rate.

Additionally, the same technique as discussed herein (wet infiltration with EMR calcination) is applicable for making ceria-containing electrodes. For example, a ceria solution (ceria nitrate) is infiltrated into a porous ceramic substrate and then calcined via EMR. In an embodiment, ceria is undoped.

### EMR Treatment Process

In various embodiments, a copper electrode is processed using a treatment process as described herein. Herein disclosed is a treatment process that comprises one or more of the following effects: heating, calcining, drying, curing, sintering, annealing, sealing, alloying, evaporating, restructuring, foaming or sintering. A preferred treatment process is sintering. The treatment process comprises exposing a substrate to a source of electromagnetic radiation (EMR). In some embodiments, EMR is exposed to a substrate having a first material. In various embodiments, the EMR has a peak wavelength ranging from 10 to 1500 nm. In various embodiments, the EMR has a minimum energy density of 0.1 Joule/cm². In an embodiment, the EMR has a burst frequency of 10⁻⁴-1000 Hz or 1-1000 Hz or 10-1000 Hz. In an embodiment, the EMR has a burst frequency of no greater than 1 Hz. In an embodiment, the EMR has an exposure distance of no greater than 50 mm. In an embodiment, the EMR has an exposure duration no less than 0.1 ms or 1 ms. In an embodiment, the EMR is applied with a capacitor voltage of no less than 100 V. For example, a single pulse of EMR is applied with an exposure distance of about 10 mm and an exposure duration of 5-20 ms. For example, multiple pulses of EMR are applied at a burst frequency of 100 Hz with an exposure distance of about 10 mm and an exposure duration of 5-20 ms. In some embodiments, the EMR consists of one exposure. In other embodiment, the EMR comprises no greater than 10 exposures, or no greater than 100 exposures, or no greater than 1000 exposures, or no greater than 10,000 exposures.

In various embodiments, metals and ceramics are sintered almost instantaneously (milliseconds for «10 microns) using pulsed light. The sintering temperature may be controlled to be in the range of 100° C. to 2000° C. The sintering temperature may be tailored as a function of depth. In one example, the surface temperature is 1000° C. and the sub-surface is kept at 100° C., wherein the sub-surface is 100 microns below the surface.

In some embodiments, the material suitable for this treatment process includes yttria-stabilized zirconia (YSZ), 8YSZ (8 mol% YSZ powder), yttrium, zirconium, gadolinia-doped ceria (GDC or CGO), samaria-doped ceria (SDC), scandia-stabilized zirconia (SSZ), lanthanum strontium manganite (LSM), lanthanum strontium cobalt ferrite (LSCF), lanthanum strontium cobaltite (LSC), lanthanum strontium gallium magnesium oxide (LSGM), nickel, NiO, NiO-YSZ, Cu-CGO, Cu₂O, CuO, cerium, copper, silver, crofer, steel, lanthanum chromite, doped lanthanum chromite, ferritic steel, stainless steel, or combinations thereof.

The treatment process of this disclosure is preferably rapid, with the treatment duration varied from microseconds to milliseconds. The treatment duration may be accurately controlled. The treatment process of this disclosure may produce fuel cell layers that have no cracks or have minimal cracking. The treatment process of this disclosure controls the power density or energy density in the treatment volume (the volume of an object being treated) of the material being treated. The treatment volume may be accurately controlled. In an embodiment, the treatment process of this disclosure provides the same energy density or different energy densities in a treatment volume. In an embodiment, the treatment process of this disclosure provides the same treatment duration or different treatment durations in a treatment volume. In an embodiment, the treatment process of this disclosure provides simultaneous treatment for one or more treatment volumes. In an embodiment, the treatment process of this disclosure provides simultaneous treatment for one or more fuel cell layers or partial layers or combination of layers. In an embodiment, the treatment volume is varied by changing the treatment depth.

In an embodiment, a first portion of a treatment volume is treated by electromagnetic radiation of a first wavelength; a second portion of the treatment volume is treated by electromagnetic radiation of a second wavelength. In some cases, the first wavelength is the same as the second wavelength. In some cases, the first wavelength is different from the second wavelength. In an embodiment, the first portion of a treatment volume has a different energy density from the second portion of the treatment volume. In an embodiment, the first portion of a treatment volume has a different treatment duration from the second portion of the treatment volume.

In an embodiment, the EMR has a broad emission spectrum so that the desired effects are achieved for a wide range of materials having different absorption characteristics. In this disclosure, absorption of electromagnetic radiation (EMR) refers to the process, wherein the energy of a photon is taken up by matter, such as the electrons of an atom. Thus, the electromagnetic energy is transformed into internal energy of the absorber, for example, thermal energy. For example, the EMR spectrum extends from the deep ultraviolet (UV) range to the near infrared (IR) range, with peak pulse powers at 220 nm wavelength. The power of such EMR is on the order of Megawatts. Such EMR sources perform tasks such as breaking chemical bonds, sintering, ablating or sterilizing.

In an embodiment, the EMR has an energy density of no less than 0.1, 1, or 10 Joule/cm². In an embodiment, the EMR has a power output of no less than 1 watt (W), 10 W, 100 W, 1000 W. The EMR delivers power to the substrate of no less than 1 W, 10 W, 100 W, 1000 W. In an embodiment, such EMR exposure heats the material in the substrate. In an embodiment, the EMR has a range or a spectrum of different wavelengths. In various embodiments, the treated substrate is at least a portion of an anode, cathode, electrolyte, catalyst, barrier layer, or interconnect of a fuel cell.

In an embodiment, the peak wavelength of the EMR is between 50 and 550 nm or between 100 and 300 nm. In an embodiment, the absorption of at least a portion of the substrate for at least one frequency of the EMR between 10 and 1500 nm is no less than 30% or no less than 50%. In an embodiment, the absorption of at least a portion of the substrate for at least one frequency between 50 and 550 nm is no less than 30% or no less than 50%. In an embodiment, the absorption of at least a portion of the substrate for at least one frequency between 100 and 300 nm is no less than 30% or no less than 50%.

Sintering is the process of compacting and forming a solid mass of material by heat or pressure without melting it to the point of liquefaction. In this disclosure, the substrate under EMR exposure is sintered but not melted. In preferred embodiments, the EMR comprises one or more of UV light, near ultraviolet light, near infrared light, infrared light, visible light, laser, electron beam, microwave. In an embodiment, the substrate is exposed to the EMR for no less than 1 microsecond, no less than 1 millisecond. In an embodiment, the substrate is exposed to the EMR for less than 1 second at a time or less than 10 seconds at a time. In an embodiment, the substrate is exposed to the EMR for less than 1 second or less than 10 seconds. In an embodiment, the substrate is exposed to the EMR repeatedly, for example, more than 1 time, more than 3 times, more than 10 times. In an embodiment, the substrate is distanced from the source of the EMR for less than 50 cm, less than 10 cm, less than 1 cm, or less than 1 mm.

In various embodiments, one or a combination of parameters may be controlled, wherein such parameters include distance between the EMR source and the substrate, the energy density of the EMR, the spectrum of the EMR, the voltage of the EMR, the duration of exposure, the burst frequency and the number of EMR exposures. Preferably, these parameters are controlled to minimize the formation of cracks in the substrate.

In an embodiment, the EMR energy is delivered to a surface area of no less than 1 mm², or no less than 1 cm², or no less than 10 cm², or no less than 100 cm². In some cases, during EMR exposure of the first material, at least a portion of an adjacent material is heated at least in part by conduction of heat from the first material. In various embodiments, the layers of the fuel cell (e.g., anode, cathode, electrolyte) are thin. Preferably they are no greater than 30 microns, no greater than 10 microns, or no greater than 1 micron.

This preferred treatment method enables tailored and controlled heating by tuning EMR characteristics (such as, wavelengths, energy density, burst frequency, and exposure duration) combined with controlling thicknesses of the layers of the substrate and heat conduction into adjacent layers to allow each layer to sinter, anneal, or cure at each desired target temperature. This process enables more uniform energy applications, decreases or eliminates cracking, which improves electrolyte performance. The substrate treated with this preferred process also has less thermal stress due to more uniform heating.

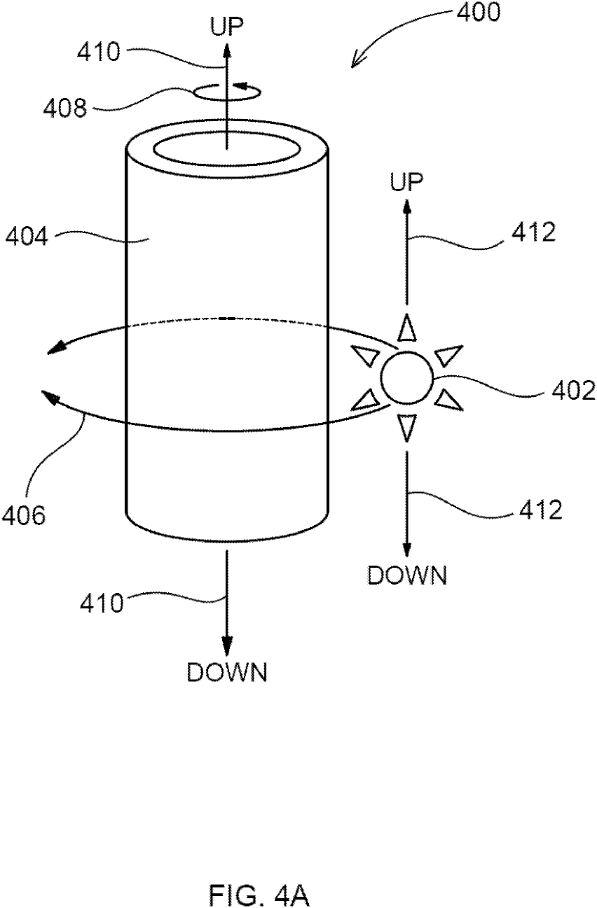

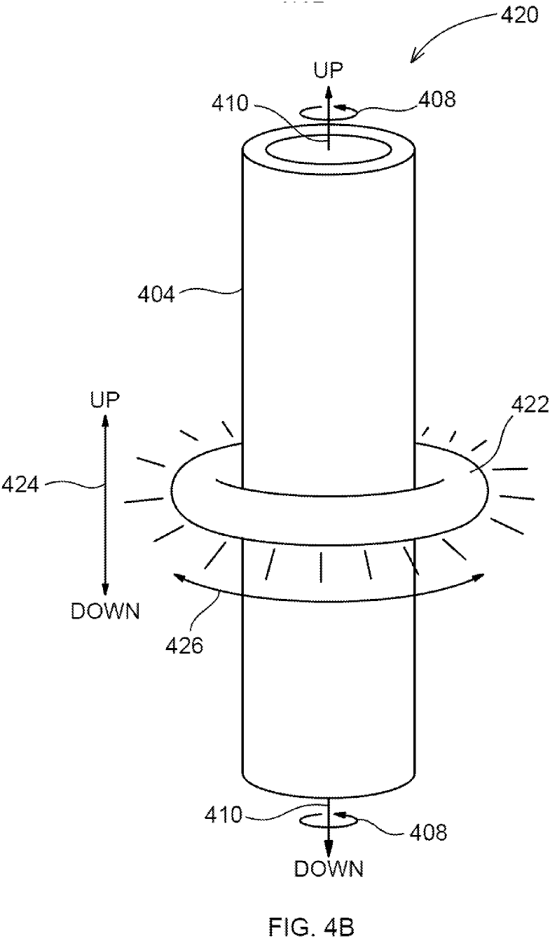

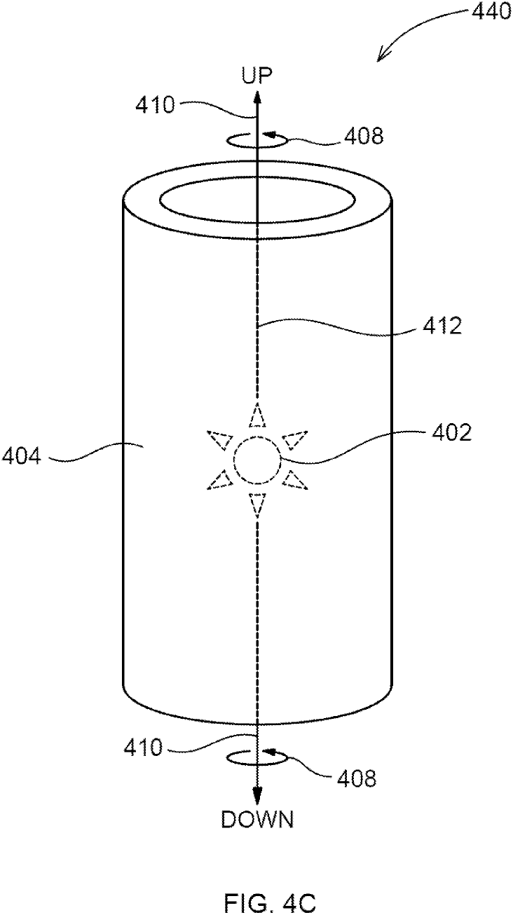

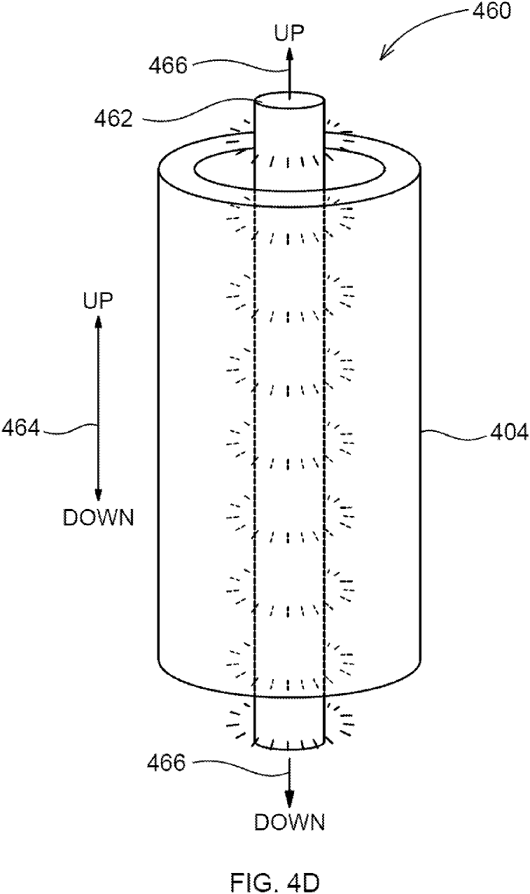

FIGS. 4A-4D illustrate various arrangements to calcine or sinter a tubular using an EMR source. The EMR source and the tubular may move relative to one another, e.g., in the axial direction or in a spiraling trajectory, to ensure the entire surface of the tubular (inner or outer) is sintered by sufficiently exposing it to the EMR source. In an embodiment, the EMR source is a xenon lamp, such as a circular xenon lamp, a long tubular xenon lamp, a point tubular xenon lamp.

FIGS. 4A-4D illustrate sintering methods and systems for manufacturing tubular EC gas producers using EMR. FIG. 4A illustrates a portion of a method of manufacture 400 of an EC gas producer using a single point EMR source, according to an embodiment of the disclosure. The EMR source (e.g., a xenon lamp) 402 and the tubular structure 404 can move relative to one another. As shown in FIG. 4A, the single point EMR 402 may rotate around the tubular structure 404 (e.g., in a spiral-like trajectory) in either direction as denoted by arrow 406. Alternatively, the tubular structure 404 may rotate around the single point EMR 402. In another embodiment, the tubular structure 404 may rotate around its own axis 408 or move in an up or down direction 410 along its own long axis or a combination thereof. The single point EMR source 402 may also move in an up or down direction 412.

FIG. 4B illustrates a portion of a method of manufacture 420 of an EC gas producer using a ring-lamp EMR source, according to an embodiment of the disclosure. As shown in FIG. 4B, a circular ring-like lamp (e.g., xenon lamp) 422 is shown as the EMR source with a hollow circle in the center. The tubular structure 404 is placed in the center of the circular ring lamp 422. In some embodiments, the tubular structure 404 may move up or down 410 or rotate 408 around its own axis while the ring lamp is 422 held in a stationary manner. In other embodiments, tubular structure 404 may be held in a stationary manner while ring lamp 422 may move along the length of tubular structure 404. Ring lamp 422 may move in an up or down 424 manner or in a manner which it rotates (426) on its own axis to assure complete and thorough sintering. In other embodiments, both the tubular structure 402 and the ring lamp 422 may both be able to move relative to each other to ensure the entire tubular structure 404 is thoroughly and completely sintered. FIGS. 4A-4B illustrate embodiments where the outer surface of the tubular structure 404 is sintered via EMR. These methods may be used to sinter anodes, cathodes, electrolytes and other components of tubular EC gas producers.

FIGS. 4C-4D illustrate the embodiment wherein the inner surface of the tubular structure 404 is sintered via EMR. FIG. 4C illustrates a portion of a method of manufacturing 440 of an EC gas producer using a single point EMR source, according to an embodiment of the disclosure. FIG. 4C illustrates a single point EMR source (e.g., a xenon lamp) 402 that is placed inside a tubular structure 404. In a first embodiment, the tubular structure 404 may be held in a stationary manner while the single point EMR source may be moved in an up or down 412 manner. In a preferred embodiment, single point EMR source 402 may irradiate substantially equally in all directions. In another embodiment, single point EMR source may be held in a stationary manner while tubular structure 404 may be moved in an up or down direction 410 or rotated 408 about its own axis. In another embodiment, the tubular structure 404 and the single point EMR source 402 both move relative to one another such that the entire inner surface of the tubular structure 404 is thoroughly and substantially sintered.

FIG. 4D illustrates a portion of a method of manufacturing 460 of an EC gas producer using a tubular EMR source, according to an embodiment of the disclosure. FIGS. 3E–4D illustrates a cylindrical lamp as the EMR source (e.g., a tubular xenon lamp) 462 that is placed inside the tubular structure 404 to be sintered. The length of the lamp in this case is such that the entire inner surface of the tubular structure 404 may be sintered without the tubular lamp 462 and the tubular structure 404 needing to move relative to one another. In one embodiment, tubular lamp 462 may be held in a stationary manner while tubular structure 404 may be moved over the lamp 462. Tubular structure 404 may be moved in an up or down manner 464. For example, unsintered tubular structure 404 may be moved over tubular lamp 462 into a specified position, remain in this position until sufficient radiation is carried out and tubular structure 404 is substantially sintered, then moved in an up or down direction as denoted by arrow 464 off of the tubular lamp 462 for the next manufacturing step. In another embodiment, unsintered tubular structure 404 may be held in a stationary position while tubular lamp EMR source 462 is moved into the tubular structure 404. Tubular lamp 462 may be moved in an up or down fashion as denoted by arrows 464. The tubular structure 404 may be formed using any suitable method, such as the methods discussed herein. For the embodiments of FIGS. 4C-4D, coating and sintering take place on the inner surface of the tubular structure 404.

Many variations are possible for sintering as illustrated in FIGS. 4A-4D. For example, an outer tubular structure 204 may be formed and thermally sintered in a furnace to form an anode or a cathode. An electrolyte material may then be coated on the inner surface of the outer tubular structure 204 and then sintered in a furnace or using a single point EMR 402 or tubular lamp EMR 462 inside of the tubular structure to form an electrolyte 206. Another electrode material may then be coated on the inner surface of the electrolyte 206 and then sintered in a furnace or using EMR source 402, 462 to form an inner tubular structure 202 such as an anode or cathode. For example, for a copper, gold, or silver-containing anode, the inner electrode is sintered using an EMR source. For example, for Ni or NiO-containing anode, the inner electrode is sintered in a furnace or by an EMR source.

In some embodiments, a combination of an EMR source inside of a tubular electrode 202, 204 or electrolyte 206 and an EMR source on the outside of a tubular electrode 202, 204 or electrolyte 206 may be used simultaneously to sinter. For example, a tubular EMR source 462 and a ring-like EMR source 422 may be used in the same sintering device to sinter sequentially or simultaneously.

### EXAMPLES

The following example is provided as part of the disclosure of various embodiments of the present invention. As such, none of the information provided below is to be taken as limiting the scope of the invention.

### Example 1 Making a Cu-CGO Electrode

A copper-containing electrode is made as follows: (1) provide a porous CGO substrate having a thickness of about 5 microns; (2) provide a copper nitrate solution having a density of about 1.2 g/mL; (3) spray the solution on the substrate and allow the solution to infiltrate the substrate; and (4) sintering the infiltrated substrate using a xenon lamp at 300V with an exposure frequency of 100 Hz for a total exposure duration of 10,000 ms. When the electrode is initiated into operation, a reducing gas (e.g., H₂ or CO) is passed through the electrode to reduce copper oxide to copper. In some cases, the CGO substrate contains cobalt.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

What is claimed is:

1. A method of making a copper-containing electrode comprising: (a) infiltrating a ceramic substrate with a copper solution; and (b) calcining the infiltrated substrate using electromagnetic radiation provided by a xenon lamp, wherein the substrate is no thicker than 50 microns.

2. The method of claim 1, wherein the ceramic substrate comprises CGO, CGO-YSZ, CGO-SSZ, SDC, SDC-YSZ, SDC-SSZ, undoped ceria, undoped ceria-YSZ, undoped ceria-SSZ, or combinations thereof.

3. The method of claim 1, wherein the ceramic substrate is formed from ceramic particles.

4. The method of claim 1, wherein the ceramic substrate is porous.

5. The method of claim 1, wherein the ceramic substrate is furnace sintered.

6. The method of claim 1, wherein the copper solution comprises copper, copper(I) nitrate, copper(II) nitrate, or combinations thereof.

7. The method of claim 1 further comprising drying the substrate between (a) and (b) using a non-contact dryer.

8. The method of claim 7, wherein said non-contact dryer comprises infrared heater, near infrared heater, hot air blower, ultraviolet light source, or combinations thereof.

9. The method of claim 1, wherein copper oxide particles remain after calcining and percolate the ceramic substrate.

10. The method of claim 1, wherein calcining the infiltrated substrate using electromagnetic radiation causes temperature of a substrate surface to reach no less than 500° C., or no less than 600° C., or no less than 800° C.

11. The method of claim 1, wherein infiltrating the ceramic substrate with the copper solution comprises depositing the solution on the substrate.

12. The method of claim 1, wherein the substrate is planar or tubular.

13. The method of claim 1, wherein the electromagnetic radiation is provided by a xenon lamp.

14. The method of claim 1, wherein the electromagnetic radiation comprises a single exposure.

15. The method of claim 1, wherein the electromagnetic radiation comprises multiple exposures with a total exposure duration and an exposure frequency.

16. The method of claim 1 comprising repeating (a) and (b) until copper percolates the ceramic substrate.

17. A method of making an electrode comprising: (a) infiltratinga ceramic substrate with a ceria solution; and (b) calcining the infiltrated substrate using electromagnetic radiation, wherein the substrate is no thicker than 50 microns.

18. The method of claim 17, wherein the ceria solution comprises ceria nitrate.

19. The method of claim 17, wherein the ceramic substrate comprises CGO, CGO-YSZ, CGO-SSZ, SDC, SDC-YSZ, SDC-SSZ, undoped ceria, undoped ceria-YSZ, undoped ceria-SSZ, or combinations thereof.

20. The method of claim 17 comprising repeating (a) and (b) until ceria percolates the ceramic substrate.
